(19) United States
(12) Patent Application Publication
(10) Pub. No.: US 2020/0042775 A1
(43) Pub. Date: Feb. 6, 2020

(54) ARTIFICIAL INTELLIGENCE SERVER AND METHOD FOR DE-IDENTIFYING FACE AREA OF UNSPECIFIC PERSON FROM IMAGE FILE

(71) Applicant: LG ELECTRONICS INC., Seoul (KR)

(72) Inventor: Sunok LIM, Seoul (KR)

(73) Assignee: LG ELECTRONICS INC., Seoul (KR)

(21) Appl. No.: 16/598,972

(22) Filed: Oct. 10, 2019

(30) Foreign Application Priority Data
Sep. 10, 2019 (KR) 10-2019-0112282

(51) Int. Cl. G06K 9/00; G06K 9/62; G06N 3/04; G06N 3/08; B25J 9/16

(52) U.S. Cl. CPC G06K 9/00295; G06K 9/6262; B25J 9/163; G06N 3/08; G06N 3/04

(57) ABSTRACT

Disclosed herein an artificial intelligence (AI) server for de-identifying a face area of an unspecific person from an image file including a communicator configured to receive a first image file from an AI apparatus of a user, and a processor configured to acquire first face information included in the first image file and second face information included in a second image file associated with the user, using a face recognition model for determining a face of a person included in the image file, determine unspecific face information, which is not included in the second face information, of the first face information as a person unknown by the user, by comparing the first face information with the second face information, and de-identify an image area of the unspecific face information determined as the unknown person from the first image file.

### CROSS-REFERENCE TO RELATED APPLICATIONS

This application claims the benefit of priority to Korean Patent Application No. 10-2019-0112282 filed in the Republic of Korea on Sep. 10, 2019, which is hereby incorporated by reference in its entirety.

### BACKGROUND OF THE INVENTION

The present disclosure relates to an artificial intelligence (AI) server and method for de-identifying a face area of an unspecific person from an image file including a video or a picture.

Artificial intelligence (AI) refers to one field of computer engineering and information technology of studying a method for making a computer think, learn, and do self-improvement, which is achieved based on human intelligence, and means that a computer emulates an intelligent behavior of the human.

AI is largely related directly and indirectly to other fields of a computer science rather than existing itself. In particular, AI elements have been modernly introduced in various fields of information technology, and there has been an active attempt to use AI to overcome problems of the fields.

Research has been actively conducted into technology of recognizing and learning a surrounding situation using AI and providing information desired by a user in the desired form or performing an operation or function desired by the user.

An electronic device for providing such various operations and functions is referred to as an AI device.

Meanwhile, when a user films a video or takes a picture, the faces of persons unknown by the user may also be filmed or photographed. When the user uploads the filmed video or the taken picture on a social network service, the faces of the persons unknown by the user may be viewed or accessible.

Accordingly, there is an increasing need for an AI server for determining the area of the face of a person unknown by a user in an image file including a video or a picture and de-identifying the face area of the unknown person.

### SUMMARY OF THE INVENTION

An object of the present disclosure is to solve the above-described problems and the other problems.

Another object of the present disclosure is to provide an artificial intelligence server and method for de-identifying the face area of an unspecific person from an image file including a video or a picture.

Another object of the present disclosure is to provide an artificial intelligence server and method capable of preventing an undesired stranger's face from being opened, by de-identifying the face area of a person unknown by a user when an image file captured by the user is uploaded on a social network to be opened to the public.

According to an embodiment, provided is an artificial intelligence (AI) server for de-identifying a face area of an unspecific person from an image file including a communicator configured to receive a first image file from an AI apparatus of a user, and a processor configured to acquire first face information included in the first image file and second face information included in a second image file associated with the user, using a face recognition model for determining a face of a person included in the image file, determine unspecific face information, which is not included in the second face information, of the first face information as a person unknown by the user, by comparing the first face information with the second face information, and de-identify an image area of the unspecific face information determined as the unknown person from the first image file.

According to an embodiment, provided is a method of de-identifying a face area of an unspecific person from an image file at an artificial intelligence (AI) server including receiving a first image file from an AI apparatus of a user, acquiring first face information included in the first image file and second face information included in a second image file associated with the user, using a face recognition model for determining a face of a person included in the image file, determining unspecific face information, which is not included in the second face information, of the first face information as a person unknown by the user, by comparing the first face information with the second face information, and de-identifying an image area of the unspecific face information determined as the unknown person from the first image file.

### BRIEF DESCRIPTION OF THE DRAWINGS

The present disclosure will become more fully understood from the detailed description given herein below and the accompanying drawings, which are given by illustration only, and thus are not limitative of the present disclosure, and wherein:

FIG. 1 illustrates an AI device 100 according to an embodiment of the present disclosure;

FIG. 2 illustrates an AI server 200 according to an embodiment of the present disclosure;

FIG. 3 illustrates an AI system 1 according to an embodiment of the present disclosure;

FIG. 4 is a flowchart illustrating a method of de-identifying the face area of an unspecific person from an image file at an AI server according to an embodiment of the present disclosure;

FIG. 5 is a flowchart illustrating a method of acquiring face information from an image file and determining whether the acquired face information corresponds to a person known by a user or a person unknown by the user at an AI server according to an embodiment of the present disclosure;

FIGS. 6 and 7 are views illustrating a face recognition model according to an embodiment of the present disclosure;

FIG. 8 is a view showing an example of an image file stored in a terminal of a user according to an embodiment of the present disclosure;

FIG. 9 is a view showing an example of an image file uploaded to an account of a user registered in a social network service according to an embodiment of the present disclosure;

FIG. 10 is a view showing an example of an image file uploaded to an account having a friend relationship with a social network service account of a user; and

FIGS. 11 to 13 are views showing a process of de-identifying an image file on an application of a terminal 100 communicating with an AI server 200.

### DETAILED DESCRIPTION OF THE EMBODIMENTS

Hereinafter, embodiments of the present disclosure are described in more detail with reference to accompanying drawings and regardless of the drawings symbols, same or similar components are assigned with the same reference numerals and thus overlapping descriptions for those are omitted. The suffixes “module” and “unit” for components used in the description below are assigned or mixed in consideration of easiness in writing the specification and do not have distinctive meanings or roles by themselves. In the following description, detailed descriptions of well-known functions or constructions will be omitted since they would obscure the disclosure in unnecessary detail. Additionally, the accompanying drawings are used to help easily understanding embodiments disclosed herein but the technical idea of the present disclosure is not limited thereto. It should be understood that all of variations, equivalents or substitutes contained in the concept and technical scope of the present disclosure are also included.

It will be understood that the terms “first” and “second” are used herein to describe various components but these components should not be limited by these terms. These terms are used only to distinguish one component from other components.

In this disclosure below, when one part (or element, device, etc.) is referred to as being ‘connected’ to another part (or element, device, etc.), it should be understood that the former can be ‘directly connected’ to the latter, or ‘electrically connected’ to the latter via an intervening part (or element, device, etc.). It will be further understood that when one component is referred to as being ‘directly connected’ or ‘directly linked’ to another component, it means that no intervening component is present.

### Artificial Intelligence (AI)

Artificial intelligence refers to the field of studying artificial intelligence or methodology for making artificial intelligence, and machine learning refers to the field of defining various issues dealt with in the field of artificial intelligence and studying methodology for solving the various issues. Machine learning is defined as an algorithm that enhances the performance of a certain task through a steady experience with the certain task.

An artificial neural network (ANN) is a model used in machine learning and may mean a whole model of problem-solving ability which is composed of artificial neurons (nodes) that form a network by synaptic connections. The artificial neural network can be defined by a connection pattern between neurons in different layers, a learning process for updating model parameters, and an activation function for generating an output value.

The artificial neural network may include an input layer, an output layer, and optionally one or more hidden layers. Each layer includes one or more neurons, and the artificial neural network may include a synapse that links neurons to neurons. In the artificial neural network, each neuron may output the function value of the activation function for input signals, weights, and deflections input through the synapse.

Model parameters refer to parameters determined through learning and include a weight value of synaptic connection and deflection of neurons. A hyperparameter means a parameter to be set in the machine learning algorithm before learning, and includes a learning rate, a repetition number, a mini batch size, and an initialization function.

The purpose of the learning of the artificial neural network may be to determine the model parameters that minimize a loss function. The loss function may be used as an index to determine optimal model parameters in the learning process of the artificial neural network.

Machine learning may be classified into supervised learning, unsupervised learning, and reinforcement learning according to a learning method.

The supervised learning may refer to a method of learning an artificial neural network in a state in which a label for learning data is given, and the label may mean the correct answer (or result value) that the artificial neural network must infer when the learning data is input to the artificial neural network. The unsupervised learning may refer to a method of learning an artificial neural network in a state in which a label for learning data is not given. The reinforcement learning may refer to a learning method in which an agent defined in a certain environment learns to select a behavior or a behavior sequence that maximizes cumulative compensation in each state.

Machine learning, which is implemented as a deep neural network (DNN) including a plurality of hidden layers among artificial neural networks, is also referred to as deep learning, and the deep learning is part of machine learning. In the following, machine learning is used to mean deep learning.

### Robot

A robot may refer to a machine that automatically processes or operates a given task by its own ability. In particular, a robot having a function of recognizing an environment and performing a self-determination operation may be referred to as an intelligent robot.

Robots may be classified into industrial robots, medical robots, home robots, military robots, and the like according to the use purpose or field.

The robot includes a driving unit may include an actuator or a motor and may perform various physical operations such as moving a robot joint. In addition, a movable robot may include a wheel, a brake, a propeller, and the like in a driving unit, and may travel on the ground through the driving unit or fly in the air.

### Self-Driving

Self-driving refers to a technique of driving for oneself, and a self-driving vehicle refers to a vehicle that travels without an operation of a user or with a minimum operation of a user.

For example, the self-driving may include a technology for maintaining a lane while driving, a technology for automatically adjusting a speed, such as adaptive cruise control, a technique for automatically traveling along a predetermined route, and a technology for automatically setting and traveling a route when a destination is set.

The vehicle may include a vehicle having only an internal combustion engine, a hybrid vehicle having an internal combustion engine and an electric motor together, and an electric vehicle having only an electric motor, and may include not only an automobile but also a train, a motorcycle, and the like.

At this time, the self-driving vehicle may be regarded as a robot having a self-driving function.

### eXtended Reality (XR)

Extended reality is collectively referred to as virtual reality (VR), augmented reality (AR), and mixed reality (MR). The VR technology provides a real-world object and background only as a CG image, the AR technology provides a virtual CG image on a real object image, and the MR technology is a computer graphic technology that mixes and combines virtual objects into the real world.

The MR technology is similar to the AR technology in that the real object and the virtual object are shown together. However, in the AR technology, the virtual object is used in the form that complements the real object, whereas in the MR technology, the virtual object and the real object are used in an equal manner.

The XR technology may be applied to a head-mount display (HMD), a head-up display (HUD), a mobile phone, a tablet PC, a laptop, a desktop, a TV, a digital signage, and the like. A device to which the XR technology is applied may be referred to as an XR device.

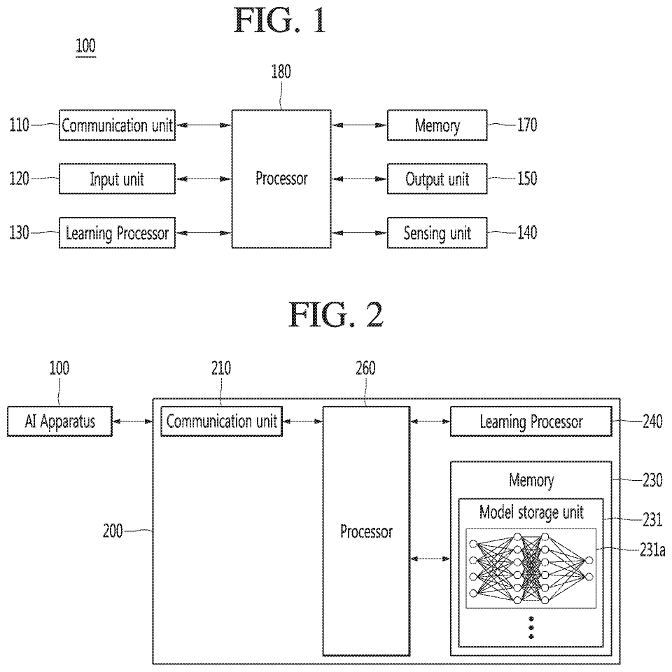

FIG. 1 illustrates an AI device 100 according to an embodiment of the present disclosure.

The AI device (or an AI apparatus) 100 may be implemented by a stationary device or a mobile device, such as a TV, a projector, a mobile phone, a smartphone, a desktop computer, a notebook, a digital broadcasting terminal, a personal digital assistant (PDA), a portable multimedia player (PMP), a navigation device, a tablet PC, a wearable device, a set-top box (STB), a DMB receiver, a radio, a washing machine, a refrigerator, a desktop computer, a digital signage, a robot, a vehicle, and the like.

Referring to FIG. 1, the AI device 100 may include a communication unit 110, an input unit 120, a learning processor 130, a sensing unit 140, an output unit 150, a memory 170, and a processor 180.

The communication unit 110 may transmit and receive data to and from external devices such as other AI devices 100a to 100e and the AI server 200 by using wire/wireless communication technology. For example, the communication unit 110 may transmit and receive sensor information, a user input, a learning model, and a control signal to and from external devices.

The communication technology used by the communication unit 110 includes GSM (Global System for Mobile communication), CDMA (Code Division Multi Access), LTE (Long Term Evolution), 5G, WLAN (Wireless LAN), Wi-Fi (Wireless-Fidelity), Bluetooth™, RFID (Radio Frequency Identification), Infrared Data Association (IrDA), ZigBee, NFC (Near Field Communication), and the like.

The input unit 120 may acquire various kinds of data.

At this time, the input unit 120 may include a camera for inputting a video signal, a microphone for receiving an audio signal, and a user input unit for receiving information from a user. The camera or the microphone may be treated as a sensor, and the signal acquired from the camera or the microphone may be referred to as sensing data or sensor information.

The input unit 120 may acquire a learning data for model learning and an input data to be used when an output is acquired by using learning model. The input unit 120 may acquire raw input data. In this case, the processor 180 or the learning processor 130 may extract an input feature by preprocessing the input data.

The learning processor 130 may learn a model composed of an artificial neural network by using learning data. The learned artificial neural network may be referred to as a learning model. The learning model may be used to an infer result value for new input data rather than learning data, and the inferred value may be used as a basis for determination to perform a certain operation.

At this time, the learning processor 130 may perform AI processing together with the learning processor 240 of the AI server 200.

At this time, the learning processor 130 may include a memory integrated or implemented in the AI device 100. Alternatively, the learning processor 130 may be implemented by using the memory 170, an external memory directly connected to the AI device 100, or a memory held in an external device.

The sensing unit 140 may acquire at least one of internal information about the AI device 100, ambient environment information about the AI device 100, and user information by using various sensors.

Examples of the sensors included in the sensing unit 140 may include a proximity sensor, an illuminance sensor, an acceleration sensor, a magnetic sensor, a gyro sensor, an inertial sensor, an ROB sensor, an IR sensor, a fingerprint recognition sensor, an ultrasonic sensor, an optical sensor, a microphone, a lidar, and a radar.

The output unit 150 may generate an output related to a visual sense, an auditory sense, or a haptic sense.

At this time, the output unit 150 may include a display unit for outputting time information, a speaker for outputting auditory information, and a haptic module for outputting haptic information.

The memory 170 may store data that supports various functions of the AI device 100. For example, the memory 170 may store input data acquired by the input unit 120, learning data, a learning model, a learning history, and the like.

The processor 180 may determine at least one executable operation of the AI device 100 based on information determined or generated by using a data analysis algorithm or a machine learning algorithm. The processor 180 may control the components of the AI device 100 to execute the determined operation.

To this end, the processor 180 may request, search, receive, or utilize data of the learning processor 130 or the memory 170. The processor 180 may control the components of the AI device 100 to execute the predicted operation or the operation determined to be desirable among the at least one executable operation.

When the connection of an external device is required to perform the determined operation, the processor 180 may generate a control signal for controlling the external device and may transmit the generated control signal to the external device.

The processor 180 may acquire intention information for the user input and may determine the user's requirements based on the acquired intention information.

The processor 180 may acquire the intention information corresponding to the user input by using at least one of a speech to text (STT) engine for converting speech input into a text string or a natural language processing (NLP) engine for acquiring intention information of a natural language.

At least one of the STT engine or the NLP engine may be configured as an artificial neural network, at least part of which is learned according to the machine learning algorithm. At least one of the SIT engine or the NLP engine may be learned by the learning processor 130, may be learned by the learning processor 240 of the AI server 200, or may be learned by their distributed processing.

The processor 180 may collect history information including the operation contents of the AI apparatus 100 or the user's feedback on the operation and may store the collected history information in the memory 170 or the learning processor 130 or transmit the collected history information to the external device such as the AI server 200. The collected history information may be used to update the learning model.

The processor 180 may control at least part of the components of AI device 100 to drive an application program stored in memory 170. Furthermore, the processor 180 may operate two or more of the components included in the AI device 100 in combination to drive the application program.

FIG. 2 illustrates an AI server 200 according to an embodiment of the present disclosure.

Referring to FIG. 2, the AI server 200 may refer to a device that learns an artificial neural network by using a machine learning algorithm or uses a learned artificial neural network. The AI server 200 may include a plurality of servers to perform distributed processing, or may be defined as a 5G network. At this time, the AI server 200 may be included as a partial configuration of the AI device 100, and may perform at least part of the AI processing together.

The AI server 200 may include a communication unit 210, a memory 230, a learning processor 240, a processor 260, and the like.

The communication unit 210 can transmit and receive data to and from an external device such as the AI device 100.

The memory 230 may include a model storage unit 231. The model storage unit 231 may store a learning or learned model (or an artificial neural network 231a) through the learning processor 240.

The learning processor 240 may learn the artificial neural network 231a by using the learning data. The learning model may be used in a state of being mounted on the AI server 200 of the artificial neural network, or may be used in a state of being mounted on an external device such as the AI device 100.

The learning model may be implemented in hardware, software, or a combination of hardware and software. If all or part of the learning models are implemented in software, one or more instructions that constitute the learning model may be stored in memory 230.

The processor 260 may infer the result value for new input data by using the learning model and may generate a response or a control command based on the inferred result value.

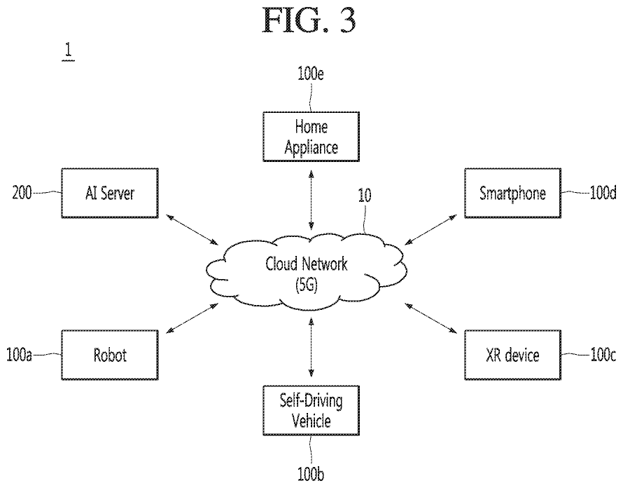

FIG. 3 illustrates an AI system 1 according to an embodiment of the present disclosure.

Referring to FIG. 3, in the AI system 1, at least one of an AI server 200, a robot 100a, a self-driving vehicle 100b, an XR device 100c, a smartphone 100d, or a home appliance 100e is connected to a cloud network 10. The robot 100a, the self-driving vehicle 100b, the XR device 100c, the smartphone 100d, or the home appliance 100e, to which the AI technology is applied, may be referred to as AI devices 100a to 100e.

The cloud network 10 may refer to a network that forms part of a cloud computing infrastructure or exists in a cloud computing infrastructure. The cloud network 10 may be configured by using a 3G network, a 4G or LTE network, or a 5G network.

That is, the devices 100a to 100e and 200 configuring the AI system 1 may be connected to each other through the cloud network 10. In particular, each of the devices 100a to 100e and 200 may communicate with each other through a base station, but may directly communicate with each other without using a base station.

The AI server 200 may include a server that performs AI processing and a server that performs operations on big data.

The AI server 200 may be connected to at least one of the AI devices constituting the AI system 1, that is, the robot 100a, the self-driving vehicle 100b, the XR device 100c, the smartphone 100d, or the home appliance 100e through the cloud network 10, and may assist at least part of AI processing of the connected AI devices 100a to 100e.

At this time, the AI server 200 may learn the artificial neural network according to the machine learning algorithm instead of the AI devices 100a to 100e, and may directly store the learning model or transmit the learning model to the AI devices 100a to 100e.

At this time, the AI server 200 may receive input data from the AI devices 100a to 100e, may infer the result value for the received input data by using the learning model, may generate a response or a control command based on the inferred result value, and may transmit the response or the control command to the AI devices 100a to 100e.

Alternatively, the AI devices 100a to 100e may infer the result value for the input data by directly using the learning model, and may generate the response or the control command based on the inference result.

Hereinafter, various embodiments of the AI devices 100a to 100e to which the above-described technology is applied will be described. The AI devices 100a to 100e illustrated in FIG. 3 may be regarded as a specific embodiment of the AI device 100 illustrated in FIG. 1.

### AI+Robot

The robot 100a, to which the AI technology is applied, may be implemented as a guide robot, a carrying robot, a cleaning robot, a wearable robot, an entertainment robot, a pet robot, an unmanned flying robot, or the like.

The robot 100a may include a robot control module for controlling the operation, and the robot control module may refer to a software module or a chip implementing the software module by hardware.

The robot 100a may acquire state information about the robot 100a by using sensor information acquired from various kinds of sensors, may detect (recognize) surrounding environment and objects, may generate map data, may determine the route and the travel plan, may determine the response to user interaction, or may determine the operation.

The robot 100a may use the sensor information acquired from at least one sensor among the lidar, the radar, and the camera to determine the travel route and the travel plan.

The robot 100a may perform the above-described operations by using the learning model composed of at least one artificial neural network. For example, the robot 100a may recognize the surrounding environment and the objects by using the learning model, and may determine the operation by using the recognized surrounding information or object information. The learning model may be learned directly from the robot 100a or may be learned from an external device such as the AI server 200:

At this time, the robot 100a may perform the operation by generating the result by directly using the learning model, but the sensor information may be transmitted to the external device such as the AI server 200 and the generated result may be received to perform the operation.

The robot 100a may use at least one of the map data, the object information detected from the sensor information, or the object information acquired from the external apparatus to determine the travel route and the travel plan, and may control the driving unit such that the robot 100a travels along the determined travel route and travel plan.

The map data may include object identification information about various objects arranged in the space in which the robot 100a moves. For example, the map data may include object identification information about fixed objects such as walls and doors and movable objects such as pollen and desks. The object identification information may include a name, a type, a distance, and a position.

In addition, the robot 100a may perform the operation or travel by controlling the driving unit based on the control/interaction of the user. At this time, the robot 100a may acquire the intention information of the interaction due to the user's operation or speech utterance, and may determine the response based on the acquired intention information, and may perform the operation.

### AI+Self-Driving

The self-driving vehicle 100b, to which the AI technology is applied, may be implemented as a mobile robot, a vehicle, an unmanned flying vehicle, or the like.

The self-driving vehicle 100b may include a self-driving control module for controlling a self-driving function, and the self-driving control module may refer to a software module or a chip implementing the software module by hardware. The self-driving control module may be included in the self-driving vehicle 100b as a component thereof, but may be implemented with separate hardware and connected to the outside of the self-driving vehicle 100b.

The self-driving vehicle 100b may acquire state information about the self-driving vehicle 100b by using sensor information acquired from various kinds of sensors, may detect (recognize) surrounding environment and objects, may generate map data, may determine the route and the travel plan, or may determine the operation.

Like the robot 100a, the self-driving vehicle 100b may use the sensor information acquired from at least one sensor among the lidar, the radar, and the camera to determine the travel route and the travel plan.

In particular, the self-driving vehicle 100b may recognize the environment or objects for an area covered by a field of view or an area over a certain distance by receiving the sensor information from external devices, or may receive directly recognized information from the external devices.

The self-driving vehicle 100b may perform the above-described operations by using the learning model composed of at least one artificial neural network. For example, the self-driving vehicle 100b may recognize the surrounding environment and the objects by using the learning model, and may determine the traveling movement line by using the recognized surrounding information or object information. The learning model may be learned directly from the self-driving vehicle 100a or may be learned from an external device such as the AI server 200.

At this time, the self-driving vehicle 100b may perform the operation by generating the result by directly using the learning model, but the sensor information may be transmitted to the external device such as the AI server 200 and the generated result may be received to perform the operation.

The self-driving vehicle 100b may use at least one of the map data, the object information detected from the sensor information, or the object information acquired from the external apparatus to determine the travel route and the travel plan, and may control the driving unit such that the self-driving vehicle 100b travels along the determined travel route and travel plan.

The map data may include object identification information about various objects arranged in the space (for example, road) in which the self-driving vehicle 100b travels. For example, the map data may include object identification information about fixed objects such as street lamps, rocks, and buildings and movable objects such as vehicles and pedestrians. The object identification information may include a name, a type, a distance, and a position.

In addition, the self-driving vehicle 100b may perform the operation or travel by controlling the driving unit based on the control/interaction of the user. At this time, the self-driving vehicle 100b may acquire the intention information of the interaction due to the user's operation or speech utterance, and may determine the response based on the acquired intention information, and may perform the operation.

### AI+XR

The XR device 100c, to which the AI technology is applied, may be implemented by a head-mount display (HMD), a head-up display (HUD) provided in the vehicle, a television, a mobile phone, a smartphone, a computer, a wearable device, a home appliance, a digital signage, a vehicle, a fixed robot, a mobile robot, or the like.

The XR device 100c may analyzes three-dimensional point cloud data or image data acquired from various sensors or the external devices, generate position data and attribute data for the three-dimensional points, acquire information about the surrounding space or the real object, and render to output the XR object to be output. For example, the XR device 100c may output an XR object including the additional information about the recognized object in correspondence to the recognized object.

The XR device 100c may perform the above-described operations by using the learning model composed of at least one artificial neural network. For example, the XR device 100c may recognize the real object from the three-dimensional point cloud data or the image data by using the learning model, and may provide information corresponding to the recognized real object. The learning model may be directly learned from the XR device 100c, or may be learned from the external device such as the AI server 200.

At this time, the XR device 100c may perform the operation by generating the result by directly using the learning model, but the sensor information may be transmitted to the external device such as the AI server 200 and the generated result may be received to perform the operation.

### AI+Robot+Self-Driving

The robot 100a, to which the AI technology and the self-driving technology are applied, may be implemented as a guide robot, a carrying robot, a cleaning robot, a wearable robot, an entertainment robot, a pet robot, an unmanned flying robot, or the like.

The robot 100a, to which the AI technology and the self-driving technology are applied, may refer to the robot itself having the self-driving function or the robot 100a interacting with the self-driving vehicle 100b.

The robot 100a having the self-driving function may collectively refer to a device that moves for itself along the given movement line without the user's control or moves for itself by determining the movement line by itself.

The robot 100a and the self-driving vehicle 100b having the self-driving function may use a common sensing method to determine at least one of the travel route or the travel plan. For example, the robot 100a and the self-driving vehicle 100b having the self-driving function may determine at least one of the travel route or the travel plan by using the information sensed through the lidar, the radar, and the camera.

The robot 100a that interacts with the self-driving vehicle 100b exists separately from the self-driving vehicle 100b and may perform operations interworking with the self-driving function of the self-driving vehicle 100b or interworking with the user who rides on the self-driving vehicle 100b.

At this time, the robot 100a interacting with the self-driving vehicle 100b may control or assist the self-driving function of the self-driving vehicle 100b by acquiring sensor information on behalf of the self-driving vehicle 100b and providing the sensor information to the self-driving vehicle 100b, or by acquiring sensor information, generating environment information or object information, and providing the information to the self-driving vehicle 100b.

Alternatively, the robot 100a interacting with the self-driving vehicle 100b may monitor the user boarding the self-driving vehicle 100b, or may control the function of the self-driving vehicle 100b through the interaction with the user. For example, when it is determined that the driver is in a drowsy state, the robot 100a may activate the self-driving function of the self-driving vehicle 100b or assist the control of the driving unit of the self-driving vehicle 100b. The function of the self-driving vehicle 100b controlled by the robot 100a may include not only the self-driving function but also the function provided by the navigation system or the audio system provided in the self-driving vehicle 100b.

Alternatively, the robot 100a that interacts with the self-driving vehicle 100b may provide information or assist the function to the self-driving vehicle 100b outside the self-driving vehicle 100b. For example, the robot 100a may provide traffic information including signal information and the like, such as a smart signal, to the self-driving vehicle 100b, and automatically connect an electric charger to a charging port by interacting with the self-driving vehicle 100b like an automatic electric charger of an electric vehicle.

### AI+Robot+XR

The robot 100a, to which the AI technology and the XR technology are applied, may be implemented as a guide robot, a carrying robot, a cleaning robot, a wearable robot, an entertainment robot, a pet robot, an unmanned flying robot, a drone, or the like.

The robot 100a, to which the XR technology is applied, may refer to a robot that is subjected to control/interaction in an XR image. In this case, the robot 100a may be separated from the XR device 100c and interwork with each other.

When the robot 100a, which is subjected to control/interaction in the XR image, may acquire the sensor information from the sensors including the camera, the robot 100a or the XR device 100c may generate the XR image based on the sensor information, and the XR device 100c may output the generated XR image. The robot 100a may operate based on the control signal input through the XR device 100c or the user's interaction.

For example, the user can confirm the XR image corresponding to the time point of the robot 100a interworking remotely through the external device such as the XR device 100c, adjust the self-driving travel path of the robot 100a through interaction, control the operation or driving, or confirm the information about the surrounding object.

### AI+Self-Driving+XR

The self-driving vehicle 100b, to which the AI technology and the XR technology are applied, may be implemented as a mobile robot, a vehicle, an unmanned flying vehicle, or the like.

The self-driving driving vehicle 100b, to which the XR technology is applied, may refer to a self-driving vehicle having a means for providing an XR image or a self-driving vehicle that is subjected to control/interaction in an XR image. Particularly, the self-driving vehicle 100b that is subjected to control/interaction in the XR image may be distinguished from the XR device 100c and interwork with each other.

The self-driving vehicle 100b having the means for providing the XR image may acquire the sensor information from the sensors including the camera and output the generated XR image based on the acquired sensor information. For example, the self-driving vehicle 100b may include an HUD to output an XR image, thereby providing a passenger with a real object or an XR object corresponding to an object in the screen.

At this time, when the XR object is output to the HUD, at least part of the XR object may be output to overlap the actual object to which the passenger's gaze is directed. Meanwhile, when the XR object is output to the display provided in the self-driving vehicle 100b, at least part of the XR object may be output to overlap the object in the screen. For example, the self-driving vehicle 100b may output XR objects corresponding to objects such as a lane, another vehicle, a traffic light, a traffic sign, a two-wheeled vehicle, a pedestrian, a building, and the like.

When the self-driving vehicle 100b, which is subjected to control/interaction in the XR image, may acquire the sensor information from the sensors including the camera, the self-driving vehicle 100b or the XR device 100c may generate the XR image based on the sensor information, and the XR device 100c may output the generated XR image. The self-driving vehicle 100b may operate based on the control signal input through the external device such as the XR device 100c or the user's interaction.

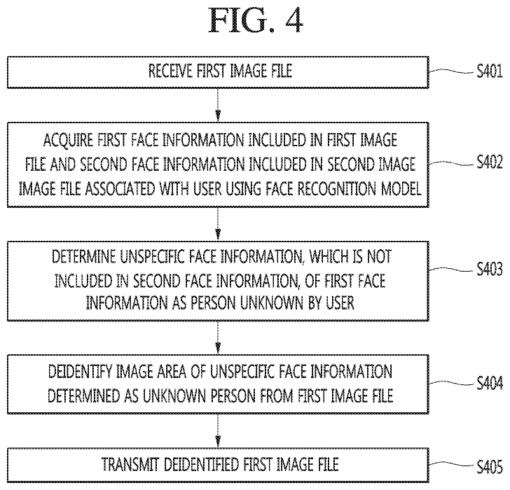

FIG. 4 is a flowchart illustrating a method of de-identifying the face area of an unspecific person from an image file at an AI server 200 according to an embodiment of the present disclosure.

The communication unit 210 may receive a first image file from the AI apparatus 100 of a user (S401).

The AI server 200 may provide a service for uploading the image file and sharing the uploaded image file with other persons.

In addition, the AI server 200 may provide a social network service. In this case, the social network service may mean a service for enabling a user to upload multimedia content including text, images, pictures, videos and live broadcasts and to share the multimedia content with their friends or all users.

In addition, a user registered in a service provided through the AI server 200 or a user registered in a social network service may mean a user who subscribed to the social network service provided by the AI server 200 as a member.

In addition, the image file may include at least one of a picture or a video.

In addition, the AI apparatus 100 of the user may be used for the user to access the AI server 200 for providing a service and to use the service. For example, the AI apparatus 100 of the user may include various apparatuses such as a robot 100a, a self-driving vehicle, an XR device 100c, a smartphone 100d, and a terminal or a home appliance 100e.

The processor 260 may acquire first face information included in the first image file and second face information included in a second image file associated with the user, using a face recognition model for determining the face of a person included in the image file (S402).

The processor 260 may acquire the first face information included in the first image file, using the face recognition model for determining the face of the person included in the image file.

The face recognition model may be an artificial neural network based model trained using a deep learning algorithm or a machine learning algorithm.

The face recognition model may use image data including a video or a picture as input data and output face information including at least one of face area position of each recognized face, face contour, eye/nose/mouth position, emotion, face direction, whether to wear makeup, gender, age, hair color, whether to wear accessories (hat/glasses/mask), blurring level, face exposure level, facial noise level, non-human face, the number of persons, the faces of which are recognized, or face recognition accuracy.

The face recognition model will be described with reference to the following drawings.

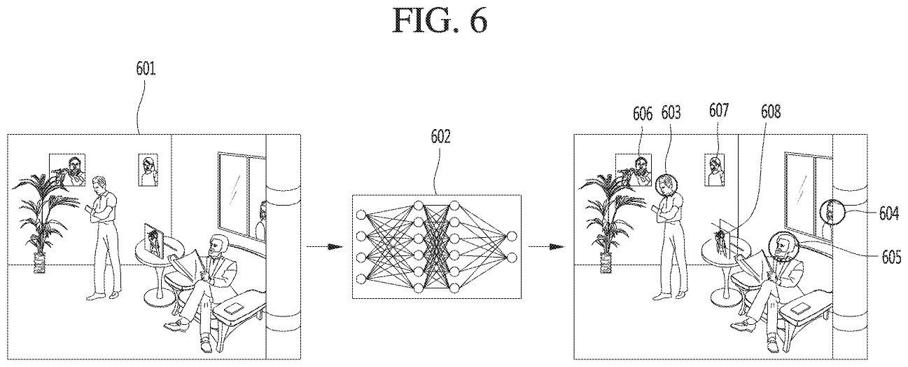

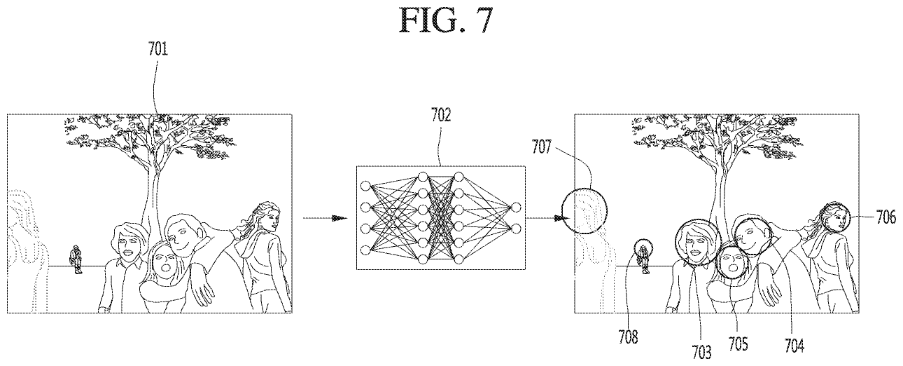

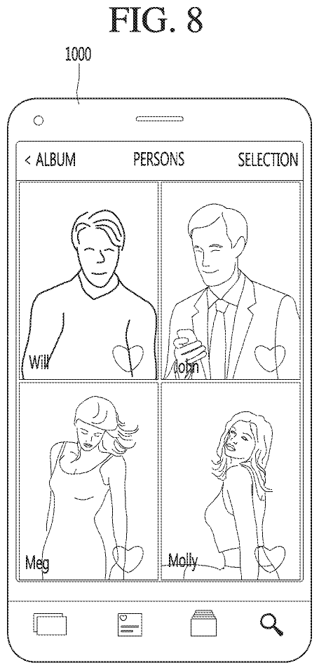

FIGS. 6 and 7 are views illustrating a face recognition model according to an embodiment of the present disclosure.

Referring to FIGS. 6 and 7, face recognition models 602 and 702 are shown.

The face recognition models 602 and 702 are artificial neural network based models which infer face information using an image file including a video or a picture as input data and using face information, which is correct answer data, as labeling data.

The face recognition models 602 and 702 may be trained by the learning processor 240 of the AI server 200. The face recognition model 602 may be stored in the model storage unit 231 of the memory 230. The processor 180 of the AI apparatus 100 may receive the face recognition model from the AI server 200 via the communication unit 110 and store the face recognition model in the memory 170.

Referring to FIG. 6, the processor 260 may provide an image file 601 to the face recognition model 602 as input data.

In addition, the processor 260 may acquire a plurality of pieces of face information 603, 604, 605, 606, 607 and 608 included in the image file 601 using the face recognition model 602.

In addition, the processor 260 may exclude a non-human face or a face having a low face exposure level by being covered by another person from a face recognition target, based on the plurality of pieces of face information.

For example, since the face information 606, 607 and 608 corresponds to non-human faces, the processor 260 may exclude the face information 606, 607 and 608 from the face recognition target. In addition, the processor 260 may exclude the face information having a low face exposure level by being covered by another object from the face recognition target. In contrast, since the face information 603 and 605 corresponds to human faces, the processor 260 may include the face information 603 and 605 in the face recognition target.

In addition, the processor 260 may determine output priority of the face information based on at least one of face recognition accuracy or a recognized face area size. The face recognition accuracy be a probability of being a human face output by the face recognition model.

In addition, the recognized face area size may be information calculated based on information on the position of the recognized face output by the face recognition model.

The output priority may mean the order of face information output to the AI apparatus 100 of the user.

For example, when the AI apparatus 100 receives a plurality of pieces of face information from the AI server 200 and displays the face information on a display, the face information may be output from the left to the right starting from highest output priority.

For example, the face information 603 may have a face area size “15129” calculated based on information on face recognition accuracy of 99.783% and a face area position (“top”: 141, “left”: 356, “width”: 123, “height”: 123). In addition, the face information 604 may have a face area size “13689” calculated based on information on face recognition accuracy of 99.678% and a face area position (“top”: 103, “left”: 297, “width”: 117, “height”: 117). Accordingly, the processor 260 may determine the output priority to give priority to the face information 603 having higher face recognition accuracy or a larger recognized face area size than the face information 605.

Referring to FIG. 7, the processor 260 may provide an image file 701 to the face recognition model 702 as input data.

In addition, the processor 260 may acquire a plurality of pieces of face information 703, 704, 705, 706, 707 and 708 included in the image file 701 using the face recognition model 702.

The processor 260 may exclude, from the face recognition target, face information having a blurring level equal to or greater than a predetermined value or face information having a face area size equal to or less than a predetermined face area size value, based on the plurality of pieces of face information.

For example, the processor 260 may exclude, from the face recognition target, face information 707 having a blurring level equal to or greater than the predetermined value and face information 708 having a face area size equal to or less than the predetermined face area size value.

In addition, the processor 260 may determine the output priority of the face information based on at least one of face recognition accuracy or a recognized face area size.

For example, the processor 260 may determine the output priority of the face information 703 having a largest face area size to be highest.

The processor 260 may acquire the second face information included in the second image file associated with the user, using the face recognition model for determining the face of the person included in the image file.

The second image file associated with the user may include an image file stored in the AI apparatus 100 of the user, an image file uploaded to the account of the user, and an image file uploaded to an account having a friend relationship with the account of the user. In this case, the account of the user may be the account of the user in the service provided through the AI server 200 or the social network service account of the user.

Accordingly, the processor 260 may acquire not only the face information of the user but also the face information of persons acquainted with the user, by acquiring the thee information from an image file associated with the user.

In addition, the second face information included in the second image file associated with the user may include previously recognized face information in the image file stored in the AI apparatus 100 of the user. For example, the processor 260 may acquire the previously recognized face information in the image file stored in the AI apparatus 100 of the user from the AI apparatus 100 of the user via the communication unit 210. In addition, the processor 260 may receive the image file stored in the AI apparatus 100 of the user via the communication unit 210, and acquire the face information included in the received image file using the face recognition model.

In addition, the memory 230 may store an image file uploaded to the account of the user registered in the service provided via the AI server 200 or the social network service. In addition, the processor 260 may acquire the face information included in the image file uploaded to the account of the user using the face recognition model.

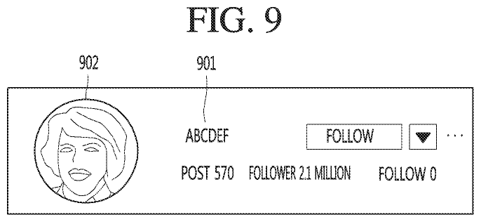

Referring to FIG. 9, the processor 260 may acquire the face information 902 included in the image file uploaded to the account “ABCDEF” 901 of the user using the face recognition model. In this case, the face information 902 may be face information of the user.

In addition, the memory 230 may store friend relationship information of the account of the user. The friend relationship information may include at least one of one or more pieces of account information or names having a friend relationship with the account of the user. Accordingly, the processor 260 may access an account having a friend relationship with the account of the user based on the friend relationship information of the account of the user. In addition, the processor 260 may access an image file uploaded to an account having the friend relationship with the account of the user. Meanwhile, the processor 260 may access the image file only when the image file is allowed to be accessed in the account of the friend relationship with the account of the user.

The processor 260 may acquire the face information included in the image file uploaded to the account having the friend relationship with the account of the user, using the face recognition model.

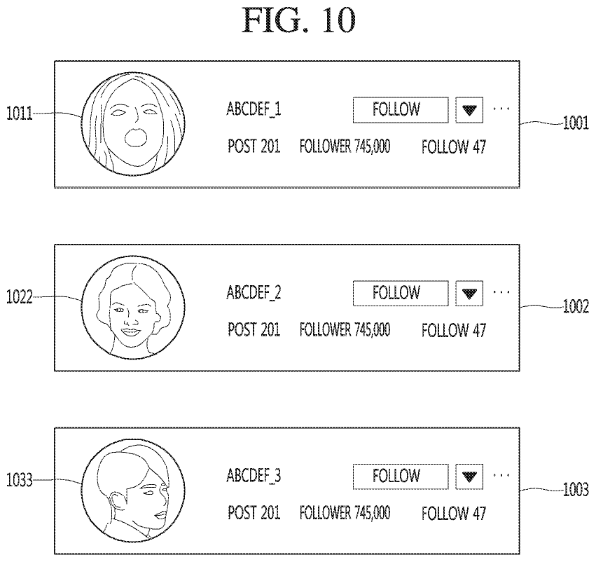

Referring to FIG. 10, face information 1011, 1022 and 1033 included in the image file uploaded to each of a plurality of accounts “ABCDEF_1”, “ABCDEF_2” and “ABCDEF_3” 1001, 1002 and 1003 having the friend relationship with the account “ABCDEF” of the user may be acquired.

The processor 260 may determine unspecific face information, which is not included in the second face information, of the first face information as a person unknown by the user, by comparing the first face information with the second face information (S403).

The processor 260 may compare the first face information included in the first image file received from the AI apparatus 100 of the user with the second face information included in the second image file associated with the user. The processor 260 may use a same-face determination model when the first face information is compared with the second face information.

The same-face determination model may be an artificial neural network based model trained using a deep learning algorithm or a machine learning algorithm.

The same-face determination model may output whether input face information corresponds to the same person and a confidence level value, using a plurality of pieces of face information as input data.

For example, the processor 260 may acquire the first image file to be uploaded to the account of the user via the communication unit 210. The processor 260 may acquire the first face information in the first image file and determine whether the first face information is the face information of a person known by the user or the face information of a person unknown by the user.

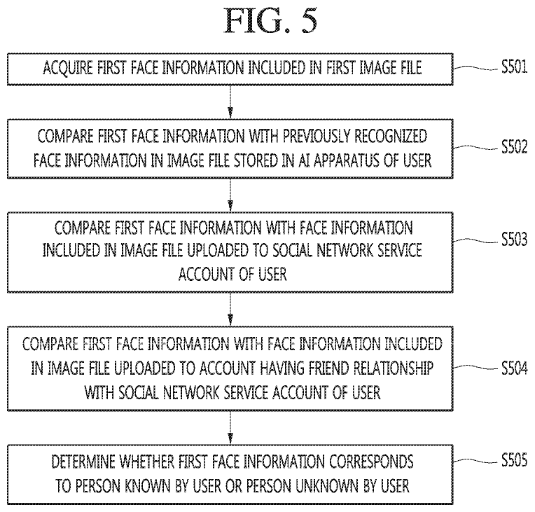

Referring to FIG. 5, the processor 260 may provide the first image file received from the AI apparatus 100 of the user via the communication unit 210 to the face recognition model to acquire the first face information (S501).

In addition, the processor 260 may acquire the second face information included in the second image file associated with the user and compare the first face information with the second face information. In this case, the second face information may be at least one of previously recognized face information in the image file stored in the AI apparatus of the user, face information included in an image file uploaded to the account of the user or face information included in an image file uploaded to an account having a friend relationship with the account of the user.

In addition, the processor 260 may compare the first face information with the second face information and acquire a result of unspecific face information, which is not included in the second face information, of the first face information and specific face information, which is included in the second face information, of the first face information.

The processor 260 may compare the first face information with the previously recognized face information in the image file stored in the AI apparatus 100 of the user (S502). The previously recognized face information in the image file stored in the AI apparatus 100 of the user may be face information acquired using the face recognition model stored in the model storage unit 231 of the AI server 200. Accordingly, the AI server 200 may increase accuracy of determination by determining a known person and an unknown person in the first image file based on the image file stored in the AI apparatus 100 of the user.

In addition, the processor 260 may compare the first face information with the face information included in the image file uploaded to the social network service account of the user (S503).

Accordingly, the AI server 200 may increase accuracy of determination based on a variety of data associated with the user, by determining a known person and an unknown person in the first image file based on the image file uploaded to the social network service account.

In addition, the processor 260 may compare the first face information with the face information included in the image file uploaded to the account having the friend relationship with the social network service account of the user (S504).

The processor 260 may determine whether the first face information corresponds to a person known by the user or a person unknown by the user, based on the result of comparing the first face information with the second face information (S505).

The processor 260 may determine unspecific face information, which is not included in the second face information, of the first face information as the person unknown by the user. In addition, the processor 260 may determine specific face information, which is included in the second face image, of the first face information as the person known by the user.

The processor 260 may transmit the specific face information determined as the known person and the unspecific face information determined as the unknown person to the AI apparatus 100 of the user via the communication unit 210. Accordingly, the AI apparatus 100 may output the received specific face information and unspecific face information as visual information via the output unit 150.

In addition, the processor 260 may transmit the friend relationship information corresponding to the specific face information determined as the known person to the AI apparatus 100 of the user via the communication unit 210. Accordingly, the AI apparatus 100 may output the received friend relationship information as visual information via the output unit 150. In this case, the user may check the friend account information of the specific face information determined as the known person.

In addition, the processor 260 may receive the friend relationship information corresponding to the unspecific face information, which is determined as the unknown person, of the first face information from the AI apparatus 100 of the user via the communication unit 210. In addition, the processor 260 may determine face information, which corresponds to the received friend relationship information, of the first face information as the person known by the user. Accordingly, the processor 260 may determine the first face information as the person known by the user based on the friend relationship information input by the user, even if the first face information included in the first image file is not determined as the same person as the second face information included in the second image file associated with the user.

The processor 260 may de-identify the image area of the unspecific face information determined as the unknown person from the first image file (S404).

The processor 260 may compare the first face information with the second face information, determine the unspecific face information, which is not included in the second face information, of the first face information as the person unknown by the user, and de-identify the image area of the unspecific face information determined as the unknown person from the first image file.

De-identification may mean that the face of the unknown person is not able to be identified by performing a mosaicking process, a blurring process, an image overwriting process, a deletion process, etc. with respect to the face area of the person unknown by the user in the image file.

The processor 260 may transmit, to the AI apparatus 100 of the user, the first image file, in which the image area of the unspecific face information determined as the unknown person is de-identified from the first image file, via the communication unit 210 (S405).

The AI apparatus 100 of the user may output the de-identified first image file via the output unit 150. Accordingly, the user may check the de-identified first image file before uploading the first image file to the social network service account.

The processor 260 may receive a request to upload the de-identified first image file from the AI apparatus 100 of the user via the communication unit 210. In this case, the processor 260 may delete the unspecific face information determined as the unknown person from the first image file. Accordingly, the AI server 200 may protect the personal information of the unknown person included in the image file uploaded by the user.

In addition, the processor 260 may provide a push notification indicating that an image file is uploaded to the account of a friend based on the friend relationship information of the specific face information determined as the known person in the de-identified first image file. In addition, the processor 260 may update the number of times of uploading the image file related to the account of the friend based on the friend relationship information of the specific face information determined as the known person in the de-identified first image file. In addition, the processor 260 may generate description information of the first image file, based on metadata including at least one of the friend relationship information of the specific face information determined as the known person in the de-identified first image file and position information in the first image file, weather information or situation information. For example, the processor 260 may generate description information such as “a picture taken with a friend “ABCDEF_1” at ABC restaurant on a rainy day” with respect to the first image file.

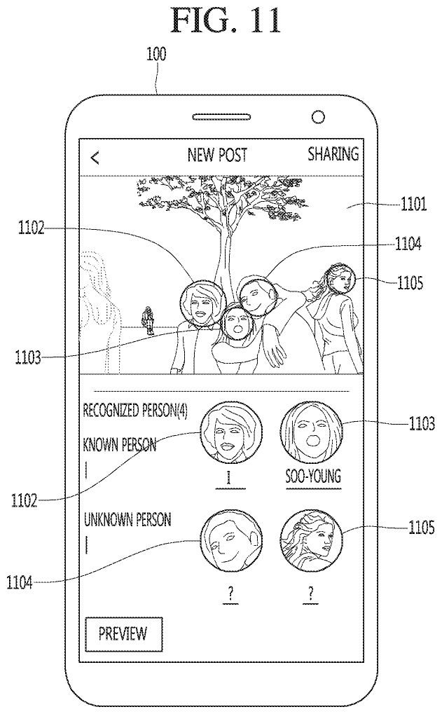

FIGS. 11 to 13 are views showing a process of de-identifying an image file on an application of a terminal 100 communicating with an AI server 200.

Referring to FIG. 11, the communication unit 210 may receive a first image file 1101 from the AI apparatus 100 of the user registered in the service provided via the AI server 200 or a social network service.

The processor 260 may acquire first face information 1102, 1103, 1104 and 1105 which is a face recognition target from the first image file 1101 using the face recognition model. In addition, the processor 260 may transmit the acquired first face information 1102, 1103, 1104 and 1105 to the AI apparatus 100 via the communication unit 210. The AI apparatus 100 may display the face area of the received first face information 1102, 1103, 1104 and 1105 or an image corresponding to the face area via the output unit 150.

In addition, the processor 260 may determine the output priority of the first face information 1102, 1103, 1104 and 1105 based on at least one of face recognition accuracy or a recognized face area size of the first face information 1102, 1103, 1104 and 1105.

The processor 260 may determine whether the first face information 1102, 1103, 1104 and 1105 corresponds to a person known by the user or a person unknown by the person, based on a result of comparing the first face information with the second face information included in the second image file associated with the user.

The processor 260 may determine unspecific face information 1104 and 1105, which is not included in the second face information, of the first face information as the person unknown by the user. In addition, the processor 260 may determine specific face information 1102 and 1103, which is included in the second face information, of the first face information as the person known by the user.

In addition, the processor 260 transmit the unspecific face information 1104 and 1105, which is not included in the second face information, of the first face information and the specific face information 1102 and 1103, which is included in the second face information, of the first face information to the AI apparatus 100 via the communication unit 210. The AI apparatus 100 may display the face area of the received unspecific face information 1104 and 1105 and specific face information 1102 and 1103 or the image corresponding to the face area via the output unit 150 in descending order of output priority of face information. In addition, the processor 260 may transmit friend relationship information corresponding to the specific face information 1102 and 1103 determined as the known person to the AI apparatus 100 of the user via the communication unit 210. In addition, the AI apparatus 100 may output the received friend relationship information via the output unit 150.

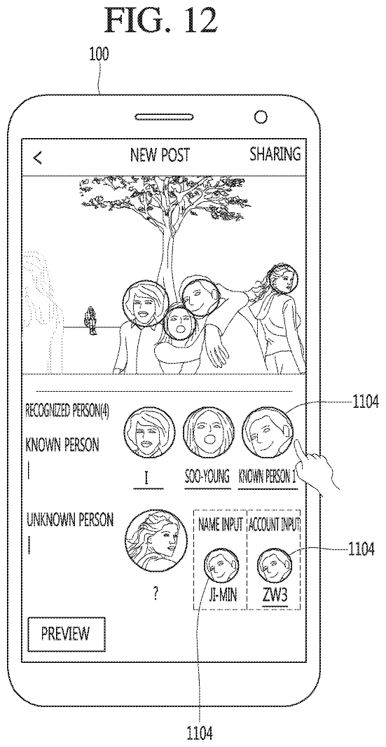

Referring to FIG. 12, the processor 260 may receive the friend relationship information corresponding to the unspecific face information 1104, which is determined as the unknown person, of the first face information from the AI apparatus 100 of the user via the communication unit 210. For example, the AI apparatus 100 may receive, from the user, the name “Ji-min” or an account ID “ZW3” of a friend which is the friend relationship information corresponding to the unspecific face information 1104 determined as the unknown person via the input unit 120. In addition, the AI apparatus 100 may transmit the received friend relationship information to the AI server 200 via the communication unit 110. In addition, the processor 260 may determine the face information 1104, which corresponds to the received friend relationship information, of the first face information as the person known by the user.

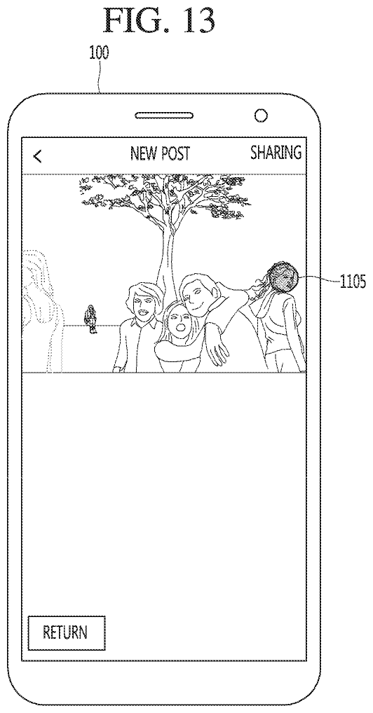

Referring to FIG. 13, the processor 260 may de-identify the image area of the unspecific face information 1105 determined as the unknown person from the first image file. In addition, the processor 260 may transmit the first image file, in which the image area of the unspecific face information 1105 determined as the unknown person is de-identified from the first image file, to the AI apparatus 100 of the user via the communication unit 210.

The AI apparatus 100 may output the first image file, in which the image area of the unspecific face information 1105 determined as the unknown person is de-identified, via the output unit 150. Accordingly, the user can check the de-identified first image file before uploading the first image file to the account of the user.

According to the embodiment, by de-identifying the face area of an unspecific person unknown by a user from an image file including a video or a picture, it is possible to protect privacy of a stranger.

According to the embodiment, it is possible to prevent an undesired stranger's face from being opened, by de-identifying the face area of a person unknown by a user when an image file captured by the user is uploaded on a social network service.

The present disclosure described above can be embodied as the computer readable codes on a medium in which a program is recorded. The computer-readable medium includes all kinds of recording devices in which data that can be read by a computer system is stored. Examples of computer-readable media include hard disk drives (HDDs), solid state disks (SSDs), silicon disk drives (SDDs), ROMs, RAMs, CD-ROMs, magnetic tapes, floppy disks, optical data storage devices, and the like. In addition, the computer may also include a processor 180 of the terminal.

What is claimed is:

1. An artificial intelligence (AI) server for de-identifying a face area of an unspecific person from an image file, the AI server comprising:
a communicator configured to receive a first image file from a device of a user; and
a processor configured to:
acquire first face information included in the first image file and second face information included in a second image file associated with the user, based on a face recognition model for determining a face of a person included in the first image file,
compare the first face information with the second face information,
determine unspecific face information in the first image file corresponding to an unknown person that is unknown to the user when the unspecific face information is not included in the second face information, and
de-identify an image area of the unspecific face information corresponding to the unknown person in the first image file to generate a modified version of the first image file including the image area of the unspecific face information being in a de-identified state.

2. The AI server of claim 1, wherein the second face information included in the second image file associated with the user includes previously recognized face information in an image file stored in the device of the user.

3. The AI server of claim 1, further comprising:
a memory configured to store an image file uploaded to an account of the user registered in a service provided via the AI server,
wherein the second image file associated with the user includes the image file uploaded to the account of the user.

4. The AI server of claim 3, wherein the memory stores friend relationship information for the account of the user registered in the service provided via the AI server, and
wherein the second image file associated with the user includes an image file uploaded to an account having a friend relationship with the account of the user.

5. The AI server of claim 1, wherein the processor is further configured to:
determine an output priority of the first face information based on at least one of face recognition accuracy of the first face information or a recognized face area size of the first face information.

6. The AI server of claim 1, wherein the processor is further configured to:
determine specific face information in the first image file corresponding to a known person that is known by the user when the specific face information is included in the second face information.

7. The AI server of claim 6, wherein the processor is further configured to:
transmit the specific face information corresponding to the known person and the unspecific face information corresponding to the unknown person to the device of the user via the communicator.

8. The AI server of claim 7, wherein the processor is further configured to:
transmit friend relationship information corresponding to the specific face information to the device of the user via the communicator.

9. The AI server of claim 1, wherein the processor is further configured to:
receive friend relationship information corresponding to the unspecific face information, and
change the unspecific face information to specific face information corresponding to a known person that is known to the user based on the friend relationship information indicating a friendship relationship with the user of the device.

10. The AI server of claim 1, wherein the processor is further configured to:
transmit the modified version of the first image file to the device of the user.

11. The AI server of claim 1, wherein the image area of the unspecific face information in the modified version of the first image file includes at least one of a mosaic effect, a blurring effect, an image overwriting, or a deletion.

12. A method of de-identifying a face area of an unspecific person from an image file at an artificial intelligence (AI) server, the method comprising:
receiving, by the AI server, a first image file from a device of a user;
acquiring first face information included in the first image file and second face information included in a second image file associated with the user, based on a face recognition model for determining a face of a person included in the first image file;
comparing the first face information with the second face information;
determining unspecific face information in the first image file corresponding to an unknown person that is unknown to the user when the unspecific face information is not included in the second face information; and
de-identifying an image area of the unspecific face information corresponding to the unknown person in the first image file to generate a modified version of the first image file including the image area of the unspecific face information being in a de-identified state.

13. The method of claim 12, wherein the second image file associated with the user includes at least one of an image file stored in the device of the user, an image file uploaded to an account of the user registered in a service provided via the AI server, or an image file uploaded to an account having a friend relationship with the account of the user registered in the service provided via the AI server.

14. The method of claim 12, further comprising:
determining an output priority of the first face information based on at least one of face recognition accuracy of the first face information or a recognized face area size of the first face information.

15. The method of claim 12, further comprising:
determining specific face information in the first image file corresponding to a known person that is known by the user when the specific face information is included in the second face information.

16. The method of claim 15, further comprising:
transmitting the specific face information corresponding to the known person and the unspecific face information corresponding to the unknown person to the device of the user.

17. The method of claim 16, further comprising:
transmitting friend relationship information corresponding to the specific face information to the device of the user.

18. The method of claim 12, further comprising:
receiving friend relationship information corresponding to the unspecific face information; and
changing the unspecific face information to specific face information corresponding to a known person that is known to the user based on the friend relationship information indicating a friendship relationship with the user of the device.

19. The method of claim 12, further comprising:
transmitting the modified version of the first image file to the device of the user.

20. The method of claim 12, wherein the image area of the unspecific face information in the modified version of the first image file includes at least one of a mosaic effect, a blurring effect, an image overwriting, or a deletion.
